(19) United States
(12) Patent Application Publication
(10) Pub. No.: US 2010/0070847 A1
(43) Pub. Date: Mar. 18, 2010

(54) Web Content Management Template Pages in a Portal

(75) Inventors: Mark Carl Hampton, Newtown (AU); Stefan Liesche, Boeblingen (DE); Stefan Hepper, Holzgerlingen (DE); Carsten Leue, Sindelfingen (DE)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/209,664

(22) Filed: Sep. 12, 2008

(51) Int. Cl. G06F 17/00

(52) U.S. Cl. 715/234

(57) ABSTRACT

A method for automated creation of portal pages by a portal for rendering content via a web content management system that provides a plurality of web content types which involves providing a set of basic portal page templates by a portal administrator and customizing each of the basic portal page templates for a specific web content type to be displayed by the portal page template, each of which basic portal page templates includes at least a rendering portlet for displaying the specific web content type, and which basic portal page templates are structured in a hierarchy. An instance of a selected basic portal page template is created which includes at least a reference to the selected basic portal page template, and the rendering portlets of the selected basic page template are linked with a specific content folder of a web content type of the web content management system utilizing a menu or drag and drop technique. Changes in the selected basic portal page template may be propagated to all basic portal page templates and their created instances of higher level in the hierarchy.

### CROSS-REFERENCE TO RELATED APPLICATION

This application is related to applicants' commonly assigned application Attorney Docket No. DE9 2008 0160 filed simultaneously herewith and entitled “SEAMLESS INTEGRATION OF WEB CONTENT MANAGEMENT CONTENT INTO PORTAL APPLICATIONS”, which is incorporated herein by this reference.

### BACKGROUND OF THE INVENTION

1. Field of the Invention

This invention relates to web portals and more particularly to methods for automated creation of portal pages by a portal for rendering content via a content management system (CMS).

2. Description of Background

Web content management (WCM) systems and portal systems are normally loosely integrated. Currently, WCM content is typically rendered via a portal server either via tunneling technology, such as iFrames™, or via dedicated portlets accessing the WCM system. Thus, the content is presently created in a WCM system and displayed through the portal server. This results in two distinct content navigation trees, a first of which is used inside the portal application and a second of which is defined in the WCM system, which therefore provides no unified user experience to the end user. In order to overcome this deficiency of the existing art, one could create portal pages that mirror the WCM content structure. However, this will work only for small content sites.

### SUMMARY OF THE INVENTION

The shortcomings of the prior art are overcome and additional advantages are provided through embodiments of the invention proposing a method for automated creation of portal pages by a portal for rendering content via a web content management system that provides a plurality of web content types which involves providing a set of basic portal page templates by a portal administrator and customizing each of the basic portal page templates for a specific web content type to be displayed by the portal page template, each of which basic portal page templates includes at least a rendering portlet for displaying the specific web content type, and which basic portal page templates are structured in a hierarchy.

According to embodiments of the invention, an instance of a selected basic portal page template is created which includes at least a reference to the selected basic portal page template, and the portlets and additional settings, like themes, skins, cache settings, and other meta data of the selected basic page template is linked with a specific content folder of a web content type of the web content management system utilizing a menu or drag and drop technique. Changes in the selected basic portal page template may be propagated to all basic portal page templates and their created instances of higher level in the hierarchy.

### TECHNICAL EFFECTS

As a result of the summarized invention, technically we have achieved a solution for implementing methods for automated creation of portal pages by a portal for rendering content via a content management system that allows template pages to be defined in a portal application that in turn allows a site administrator to pre-define the overall layout of the content pages and the content author to simply provide the content to specific topics.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow chart that illustrates an example of existing art portal page creation process flow;

FIG. 2 is a flow chart that illustrates an example of process flow for embodiments of the invention;

FIG. 3 is a schematic diagram that illustrates use of templates in the process for embodiments of the invention;

FIG. 4 is a sample user interface (UI) in connection with the use of templates in the process for embodiments of the invention; and

FIG. 5 is a diagram that illustrates an example of the creation of a template hierarchy for embodiments of the invention.

The detailed description explains the preferred embodiments of the invention, together with advantages and features, by way of example with reference to the drawings.

### DETAILED DESCRIPTION OF THE INVENTION

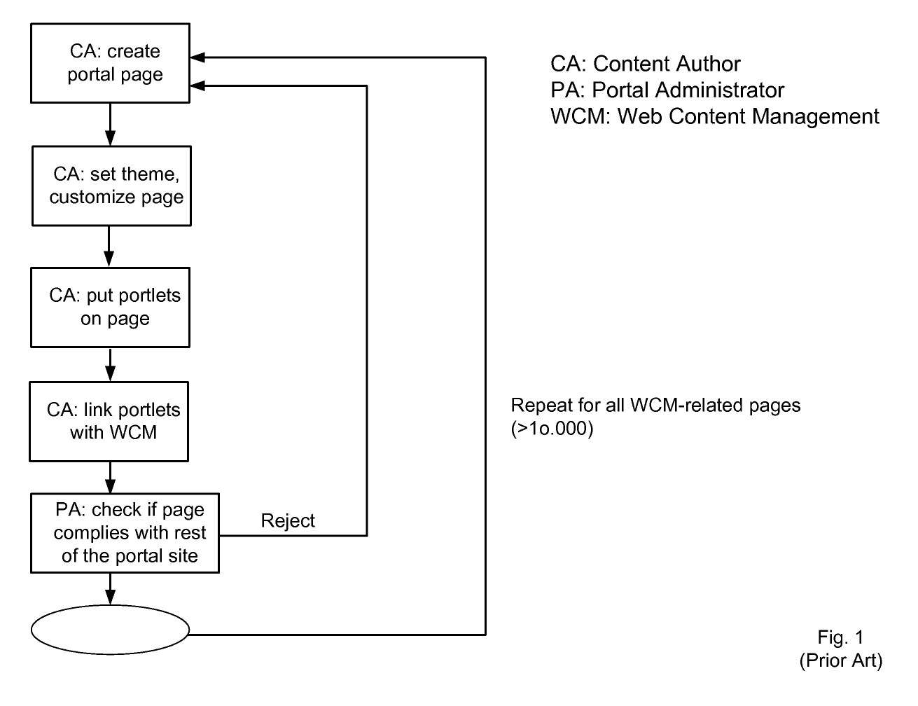

Currently, a portlet is not typically provided for every field on the web content. In other words, there is not one portlet that shows the title, another portlet that shows the author, another portlet for the body, and so forth. Instead, each content portlet shows multiple elements of the content item. For example, one portlet may show the title, the author, and the body, and another portlet may show a set of downloads and links. Accordingly, the content within a portlet must have a layout as well which decides how these multiple elements from the content item sit inside the portlet. FIG. 1 is a flow chart that illustrates an example of existing art portal page creation process flow.

Embodiments of the invention allow template pages to be defined in the portal application that in turn allows a site administrator to pre-define the overall layout of the content pages and the content author to simply provide the content to specific topics. The site administrator can later change the template and decide to apply the changes to all its children or only to newly created content pages. This results in a centrally managed layout for content pages and thus reduces the administration costs as the number of content pages in a portal application may range in the tens of thousands.

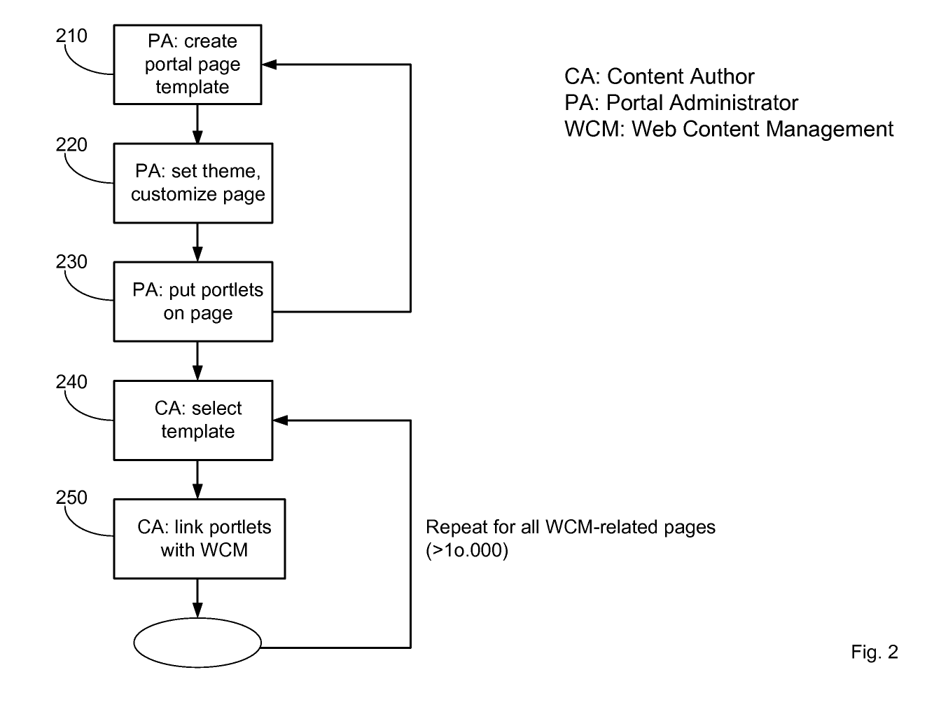

FIG. 2 is a flow chart that illustrates an example of process flow for embodiments of the invention. Referring to FIG. 2, at 210, a basic portlet page template is created by the portal administrator, and at 220, a theme is set and the page is customized for a specific web content type to be displayed by the portal administrator. At 230, portlets are placed on the page by the portal administrator. At 240, a template is selected by a content author, and at 250, the portlets are linked with the web content management system by the content author.

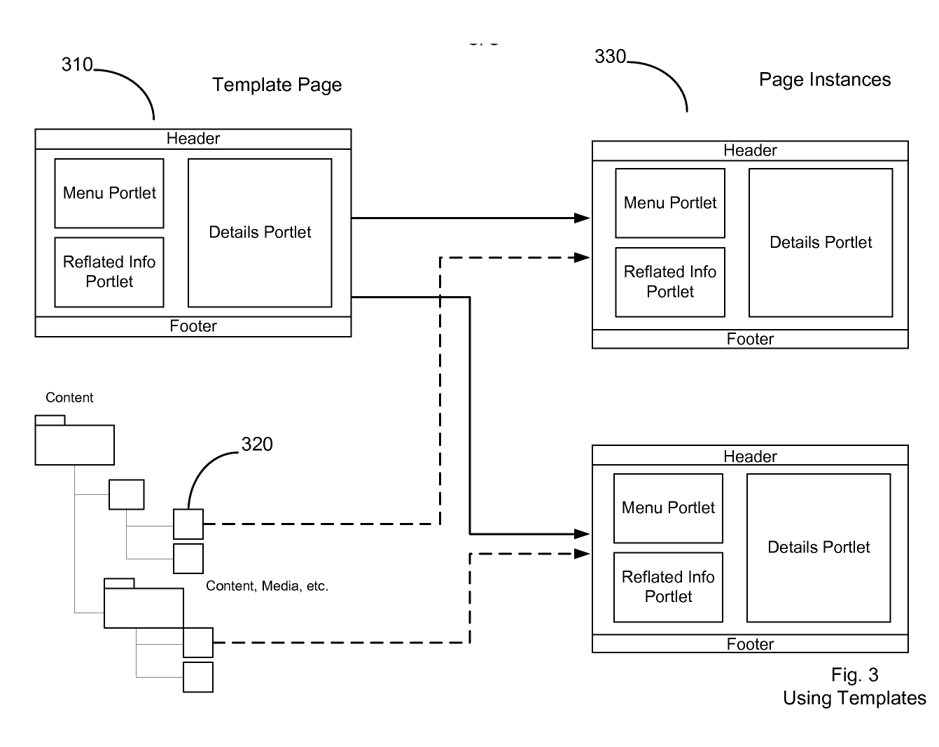

FIG. 3 is a schematic diagram that illustrates use of templates in the process for embodiments of the invention. A template 310 can be used by the content authors and linked with a specific content folder 320. When a template 310 is used, a concrete page instance 330 is created that still has a reference back to the template 310. Content authors may be allowed to modify a created page, e.g., by removing portlets or adding additional portlets. Portal administrators can later change the template and push these changes to all page instances created from the particular template, thereby avoiding the manual process of doing so for every page.

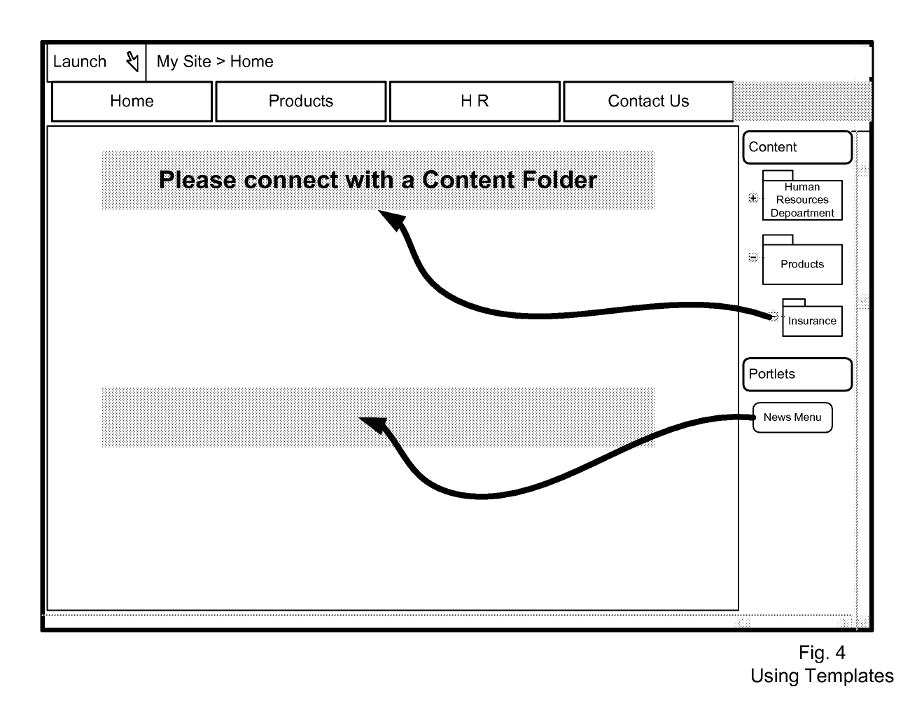

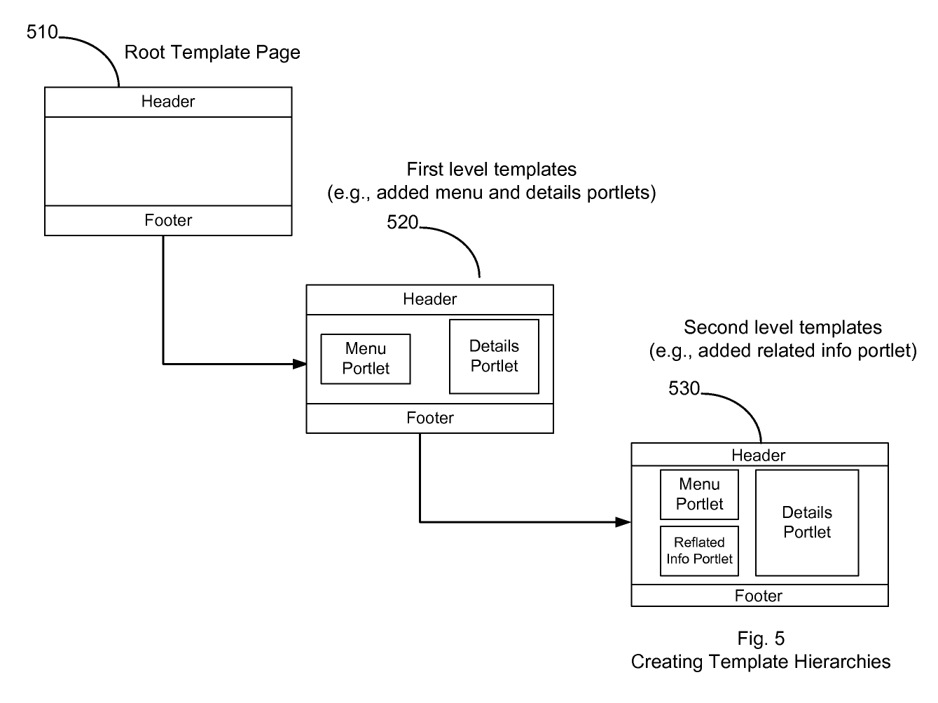

FIG. 4 is a sample user interface (UI) in connection with the use of templates in the process for embodiments of the invention. FIG. 5 is a diagram that illustrates an example of the creation of a template hierarchy for embodiments of the invention. The template 510 itself can be structured in a hierarchy which allows common parts to be separated in the higher levels of the template tree and which also allows matters in the base template 510 to be changed and the changes propagated to all templates 520, 530 and all page instances of the particular template.

Embodiments of the invention thus make it possible to ensure that page layouts (e.g., themes and skins) match the layouts within the content portlets (i.e., are all coherent and consistent) and that content to be displayed in multiple locations (i.e. different portals with different themes) is displayed consistently. Further, embodiments of the invention make it possible to define template pages based on different means, such as putting the template pages under a specific parent node, explicitly tagging the template pages as template pages when creating the page, and/or tagging the template pages with tags related to the page and searching for a template page via tags, which also makes it possible to make any page that seems useful as a template page into a template.

According to embodiments of the invention, templates can be either dynamic pages (e.g., portal page with dynamic content) or static pages (e.g., static HTML with semantic tags for including portlets). Changes made on a template page can be propagated to its child pages. If conflicts arise, different conflict resolution schemes may be applied. The template page allows the site administrator to define specific templates, portlets, default content folder, and content navigation rules.

The method for automated creation of portal pages by a portal for rendering content via a web content management system that provides a plurality of web content types involves, for example, providing a set of basic portal page templates by the portal, each of which basic portal page templates is customized for the specific web content type it displays, each of which includes at least a rendering portlet for displaying that specific web content type, and which basic portal page templates are structured in hierarchies. An instance of a selected basic portal page template which includes a reference to its basic template is created, and the rendering portlet of the basic page template is linked with a specific content folder of a web content type of the web content management system by using a menu or a drag and drop technique. Changes in a basic portal page template of lower level in the hierarchy are automatically propagated to all basic portal page templates and their created instances of higher level in the hierarchy.

The flow diagrams depicted herein are only examples. There may be many variations to these diagrams or the steps (or operations) described therein without departing from the spirit of the invention. For example, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer implemented method for automated creation of portal pages by a portal for rendering content via a web content management system that provides a plurality of web content types, comprising:
providing a set of basic portal page templates by a portal administrator;
customizing each of the basic portal page templates for a specific web content type to be displayed by said each of the basic portal page templates, each of which basic portal page templates includes at least one rendering portlet for displaying the specific web content type, and each of which basic portal page templates is structured in a hierarchy comprising a basic portal page template root and a pre-determined number of successive basic portal page template levels, each of said successive basic portal page template levels further comprising at least one content element cumulatively added to an immediately preceding basic portal page template level;
creating an instance of a selected basic portal page template which includes at least a reference to the selected basic portal page template;
linking the selected basic page template and said at least one rendering portlet on said selected basic page template with a specific content folder of a web content type of the web content management system utilizing a menu or drag and drop technique; and
propagating changes in the selected basic portal page template to said basic portal page template root and said pre-determined number of successive basic portal page template levels for said basic portal page template and created instances of higher level in said hierarchy.
